(19) United States
(12) Patent Application Publication
(10) Pub. No.: US 2006/0026001 A1
(43) Pub. Date: Feb. 2, 2006

(54) Enhanced communications services for the deaf and hard of hearing cross-reference to related applications

(75) Inventors: Philip William Bravin, Pelham Manor, NY (US); Benjamin John Soukup JR., Sioux Falls, SD (US); Randy Arthur Gerloff, Brandon, SD (US)

Correspondence Address: COMMUNICATION SERVICES FOR THE DEAF, INC., 102 N. KROHN PL., SIOUX FALLS, SD, 57103-1800, US

(73) Assignee: Communication Service for the Deaf, Inc.

(21) Appl. No.: 11/238,450

(22) Filed: Sep. 29, 2005

Related U.S. Application Data
(62) Division of application No. 09/942,924, filed on Aug. 31, 2001.

(51) Int. Cl. G10L 21/00

(52) U.S. Cl. 704/270.1

(57) ABSTRACT

A system and method for a deaf party to communicate in a sign language by way of a video computing device to relay center having a sign language interpreter. A relay system receives a sign language input from the deaf party. Then, a spoken message is relayed to the hearing party that corresponds to the received sign language input. The relay system may also receive a spoken message from the hearing party. Then a sign language message is relayed to the deaf party corresponding to the spoken message via relay communication link.

### CROSS-REFERENCE TO RELATED APPLICATIONS The present divisional application claims the benefit of priority to U.S. patent application Ser. No. 09/942,924 filed Aug. 31, 2001.

### FIELD OF THE INVENTION

The present invention generally relates to the processing of communications between speaking and deaf and hard of hearing individuals, in particular, to enhanced communications services for deaf and hard of hearing individuals using relay services.

### BACKGROUND OF THE INVENTION

Telecommunications relay services (“TRS”) or Dual Party Relay Services (“DPRS”) enable deaf, hard of hearing, or speech impaired individuals to employ text telephones for engaging in a communication session over a telephone network with a person who has a conventional voice telephone. Deaf, hard of hearing, or speech impaired individuals (hereinafter also referred to as deaf persons or parties) utilize Text Telephones, such as Telecommunication Devices for the Deaf (TDD), to communicate over the telephone with hearing and speaking parties (hereinafter referred to as hearing party) using conventional telephones. The deaf person typically uses a keyboard on the TDD or TTY, a specially equipped device with a keyboard, to communicate with a relay operator who voices what the deaf person types to the hearing person on the other end over the telephone. A typical TDD has an alphanumeric keyboard and either a full screen or a single line character display and uses BAUDOT or ASCII signaling or both.

FIG. 1 illustrates a typical TRS environment 1 having a text telephone for a deaf party. A hearing party 3 places a call using a conventional voice telephone 5 to a TRS center 7 in a speaking environment. The TRS center 7 includes a Communication Assistant (CA) 9 who relays the call to a text telephone 11, communicating in a text environment by transcribing the call, so that a deaf party 13 can communicate with the hearing party 3. The CA 9 acts as a translator between hearing party 3 and deaf party 13 by being an operator who transcribes and to connects the calls. The TRS environment 1 also works in reverse, where deaf party 13, can initiate the telephone call to the hearing party 3 with the CA 9 performing the same function as described above.

The TRS environment is widely used and has become indispensable to the deaf and hard of hearing community. While telecommunications relay services have enabled deaf individuals to communicate to hearing persons in the mode of the hearing person, e.g. voice and speaking, the system has certain drawbacks for the deaf person. The deaf individual must use a TDD/TYY device or similar text-based environment to communicate with the communications assistant, which can be inefficient, frustrating and unnatural for some individuals. The flow of communications in this text-based environment can be cumbersome and unnatural for some users. This two-way communication can be limited to transcription and the speed of the typists and use of code words. A deaf person must type a text message, which upon concluding input of the text message, inputs an end-of-message code word, such as “GA”, that stands for “go ahead”, indicating that he has completed his message. The hearing and speaking person at a voice telephone hears the code word, e.g., “GA” or “go ahead” and then they can speak. Accordingly, the TRS system can be greatly improved to enhance communication options for deaf/hard of hearing individuals.

Recognizing some of the drawbacks of the TRS environment, there have been past attempts or trials for testing of video relay interpreting. These test systems had several drawbacks and problems. Notwithstanding the problems, these video relay interpreting trials lacked certain features that enabled full use of the communication modes for deaf/hard of hearing individuals to hearing parties. In particular, among other problems, these test video relay interpreting systems lacked a temporary messaging facility, Internet or World Wide Web capability, and a profile systems for subscribers. In addition, these test systems lacked the ability of deaf/hard of hearing parties to have a selective choice of an audio identity as to having the transmitted voice of the interpreter into other voice profiles. While, test systems showed on a limited basis video relay interpreting, many improvements to these systems were needed.

Therefore, what is needed is an improved system and method that enables deaf, hard of hearing, or speech-impaired individuals the capability to communicate in a natural manner and to be able to converse over a communications network in a manner that overcomes the drawbacks in traditional telecommunications relay services and conventional video relay interpreting systems.

### BRIEF SUMMARY OF THE INVENTION

In view of the foregoing, the present invention is directed to a system and a method of video relay services that overcomes the problems with telecommunications relay services and conventional video relay interpreting systems.

One aspect of the invention provides a video relay system for facilitating communications between a deaf party and a hearing party, in which the video relay system includes an interpreter. The video relay system includes a video server unit for receiving and recording a sign language message from the deaf party. A video processing unit is operatively coupled to the video server unit via a local area network. The video processing unit displays the recorded sign language message to the interpreter so as to translate the recorded sign language message into an audio message for later transmission to the hearing party. In this manner, the deaf party converses in a natural language that enables more effective communication of information.

A further aspect of the invention provides a video relay system implementing a method of facilitating communications between a calling party and a called party using an interpreter. A request is received from the calling party for communicating with the called party. The video relay system attempts to establish communications with the called party and receives an unavailable status of the called party. In response to receiving the unavailable status, the video relay system receives at least one of a sign language message for storage in a video storage device and an audio message for storage in a voice mail device corresponding to a message mode identifier. The message mode identifier is transmitted to the called party. When the called party has an available status, the video relay system relays the sign language message or the audio message to the called party responsive to receiving the message mode identifier. In this way, the video relay system serves as a communication messaging center for hearing individuals and deaf/hard of hearing individuals.

In another aspect of the invention provides a method of remote video interpreting using a relay system to facilitate communications between a deaf party using a video communication platform and a hearing-party using an audio telephony platform. The relay system includes a plurality of interpreters. In the method, a request is received for a network connection to the hearing-party from the deaf party. A predetermined profile is retrieved for the deaf party, in which the predetermined profile includes at least a language preference. In the response to the step of retrieving, the deaf party is prompted, corresponding to the language preference, for a network address linked to the audio telephony platform. The network connection is established to the network address having the audio telephony platform of the hearing-party. The relay system receives a real-time sign language input from the video communications platform of the deaf party. The real-time sign language input is formatted directly into spoken words while relaying to the hearing-party that corresponds to the formatted real-time sign language input from the deaf party.

In one aspect of the remote video interpreting system, the relay center retains a predetermined identity code established by the deaf party so that the audio telephony platform receives the spoken message in a synthesized voice corresponding to a predetermined digital voice profile. In another aspect, the video communication platform further includes a memory for storing the predetermined identity code for transmission through the first relay link to the relay center, the identity code causes the relay center to transmit a synthesized voice through the second relay link corresponding to a preselected voice profile. In this manner, a virtual audio identity for the deaf party is created.

### BRIEF DESCRIPTION OF THE DRAWINGS

The foregoing summary of the invention, as well as the following detailed description of the preferred embodiments, is better understood when read in conjunction with the accompanying drawings, which are included by way of example and not by way of limitation with regard to the claimed invention wherein:

FIG. 1 is a schematic block diagram of a conventional telecommunications relay service;

FIG. 2 is a schematic block diagram of an embodiment of a video communications relay network according to the teachings of the present invention;

FIG. 3 is a schematic diagram of a video computing device for implementing a video communications relay network according the teaching to the present invention;

FIG. 4A is a schematic block diagram of a second embodiment of a video communications relay network according to the teachings of the present invention;

FIG. 4B is a flow diagram illustrating an embodiment of processing a message within the network shown in FIG. 4A;

FIG. 4C is a portion of the embodiment of processing a message shown in FIG. 4B.

FIG. 5 is a schematic block diagram of a third embodiment of a video communications relay network according to the teachings of the present invention;

FIG. 6 is a schematic representation of a subscriber profile for implementation in a video communications relay network;

FIG. 7 is a schematic representation of a subscriber look-up table; and

FIG. 8 is a schematic representation of a greeting look-up table.

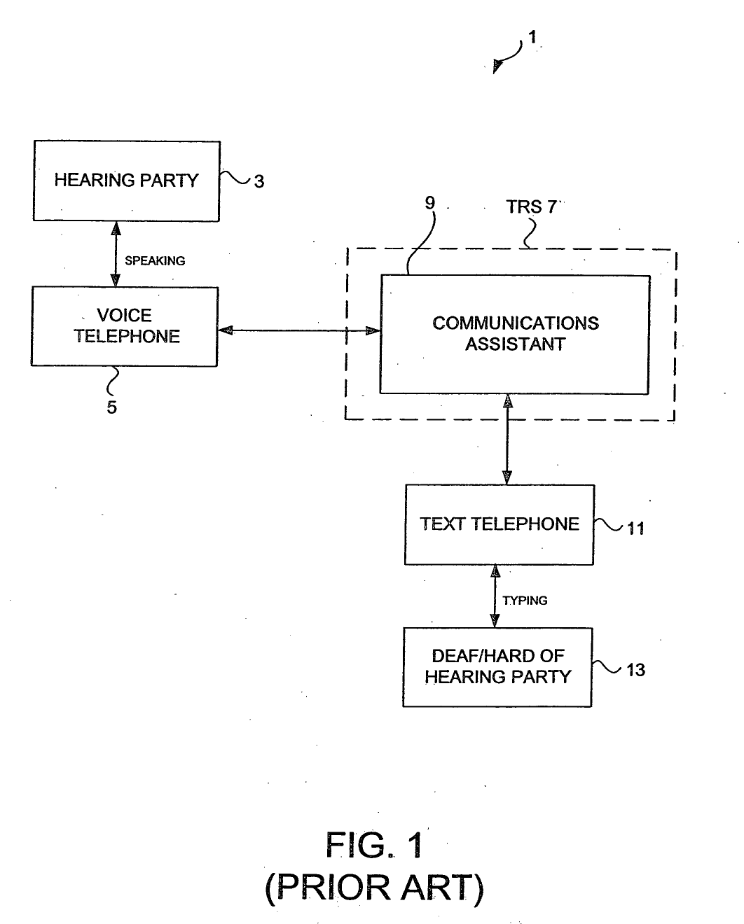

### DETAILED DESCRIPTION OF THE INVENTION

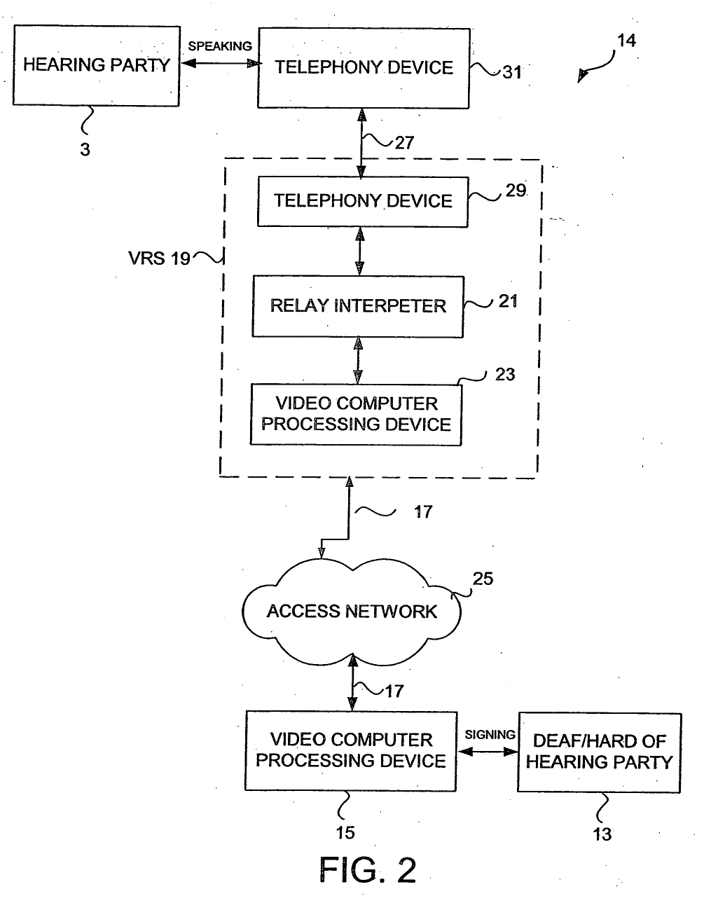

FIGS. 2-8 illustrate preferred embodiments of a system and method of providing enhanced communication services for deaf and hard of hearing individuals. For ease of explanation the terms “deaf or hard of hearing” referred to a person who is deaf, hard of hearing, or speech-impaired. Likewise, the term “hearing party” or “hearing person” refers to a person who able to hear and speak into a telephone or similar device. Referring to FIG. 2, there is shown a first embodiment of a system and method for providing a video communications relay network 14 of the present invention. As a functional overview, the illustrated a video relay service enables deaf individuals to access a live sign language interpreter via a communications network, such as the Internet or World-Wide-Web, so as to use sign language to communicate with the hearing party via the voice of the interpreter. Advantageously, the deaf party converses in a natural language that enables more effective communication of information.

Referring to FIG. 2, one approach to a video relay service includes, a deaf party 13 desiring to communicate with a hearing party 3 over a telecommunications network. In this approach, deaf party 13 uses a first video computer processing device (VCPD) or video communication platform 15 to establish a first communications relay data link 17 with a video communications relay service (VRS) center 19 having a relay interpreter 21, such as a video interpreter. In addition, relay interpreter 21 employs a second compatible video computer processing device (VCPD) 23 or other system to receive and transmit a video signal via first relay data link 17.

The first relay data link 17 is established through an access network 25, in which first VCPD 15 has a first network address and the relay service has a second network address. The first relay data link can be any number of high-speed data lines or data modem connections, including virtual private links through access network 25. First relay data link 17 may include, digital subscriber line (DSL) network, broadband cable, an Integrated Services Digital Network (ISDN) line, fixed wireless broadband network, or Plain Old Telephone Service (POTS). One of ordinary skill in the art generally has knowledge of ISDN, DSL, and broadband networks. While a single relay interpreter, a single hearing party, and a single deaf party are depicted in FIG. 2, the video communications relay service center 19 can include a multiplicity of users with a relay interpreter for facilitating each conversation between the parties.

Access network 25 may comprise a number of differing networks, including local, national, or international networks, such as the Internet, the World Wide Web, a cable television (CATV), a satellite communication, or a broadband network. Access network 25 comprises hardware and software for transmission of data packets across the network. Access network 25 may include a plurality of routing switches (not shown) for transmitting and routing data packets between video communications relay center and first VCPD 15 of deaf party 13. In general, the first and second network addresses are end points connected to access network 25 and have unique addresses for end-to-end communications. In one arrangement, the first network address is a videophone number.

With reference to FIG. 2, in one arrangement, video communications relay center 19 may have a local area network that provides network connectivity and routing of data packets to a one or more video computer processing devices 23 used by the interpreters 21. In addition, the local area network may include host computers for executing one or more web-applications for displaying web pages and/or conducting video communications relay services transactions. It should be recognized that the local area network may have Transmission Control Protocol/Internet Protocol (TCP/IP) as a transportation medium. This arrangement enables subscribers advantageously use the Internet for the communications between the parties in which first relay data link 17 is an IP connection. In addition, access network 25 enables the visual output from VCPD 15 and 23 to be transmitted via an electronic carrier wave through data lines or an air medium.

With continued reference to FIG. 2, a first phase of the communications provides for a video-to-voice mode of relay communications. The relay interpreter 21 determines with whom the deaf party desires to communicate and establishes a second connection 27 of the communications relay. This can be accomplished by transmitting a prerecord message in sign language to VCPD 15 so as to prompt the hearing impaired party for information. In this manner, interpreter 21 is freed to perform other tasks.

In one arrangement, the second connection 27 may be a voice telephony link from a first telephony device 29 or audio communications platform at the relay interpreter position to the desired hearing person at a second telephony device 31. The voice telephony link can be established through a Public Switch Telephone Network (PSTN), the Internet via Voice Over Internet Protocol (VoIP), or wireless cellular network. First and second telephony devices 29,31 can be any appropriate device that interfaces with the networks to provide the voice telephony link, such as a personal computer equipped with a voice modem, a conventional telephone, a wireless phone, a laptop with a modem, a telephony-enabled personal digital assistant, a handheld terminal device, a palm-sized computer, or an IP-enabled telephone.

Advantageously, communication between deaf party 13 and hearing party 3 proceeds by alternating between visual sign language communication and voice communication, in which relay interpreter 21 translates between the two parties. In visual sign language communication, the deaf person inputs a visual message into the first VCPD 15. While, deaf party 13 is transmitting the visual sign language message to the relay center, relay interpreter 21 interprets and speaks or voices the visual message into first telephony device 29. In such a manner, relay interpreter 21 relays the visual message to the hearing party 3 so that the message input by the deaf party can be understood accordingly. It should be recognized that the deaf party indicates that he has completed his message in sign language.

With continued reference to FIG. 2, after hearing party 3 determines pauses or voice cues emanating from the voice of relay interpreter 21, as in general voice communications, hearing party 3 begins the second phase of the communications relay by speaking his own message into second telephony device 31. Relay interpreter 21 hears, via the first telephony device 29, what hearing party 3 speaks, interprets and signs the message into second VCPD 23 for transmission to first VCPD 15. First VCPD 15 receives the message from hearing party 3 in the form of a visual sign language message such that deaf party 13 can read the message in sign language. Then, the deaf party can input visual signs into first VCPD 15 back to relay interpreter 21 to respond to hearing party 3.

It should be recognized that a second approach to a video relay service, includes a hearing party desiring to contact a deaf party. In that approach, the process is reversed, in which the first phase of communication is a voice-to-video mode when a hearing party contacts the video communication relay center to communicate with deaf party 13. The second phase of communication occurs when the deaf person responds in sign language to relay interpreter 21.

In an arrangement of the first embodiment, first telephony device 29 at video communications relay center 19, may include a voice synthesizer which comprises hardware and software for synthesizing the outbound voice of the interpreter 21 in other voice type characteristics. The voice synthesizer may be advantageously configured to match the deaf party's 13 physical characteristics so as to reflect his/hers identity and/or background and also to create a sense of a virtual audio identity for the deaf party.

In general, the deaf party may want a choice of how the conservation is conveyed to the hearing party. For example, the voice synthesizer may be programmed to generate a predetermined digital voice profile of a person that which closely resembles the deaf party. In another case, the voice synthesizer may be programmed to generate a certain type female voice or male voice. Other voices may be supplied with existing voice computer telephony printed circuit boards with interfacing driver software. In a further arrangement, the predetermined digital voice profile may be a digitized voice imprint of the voice of the deaf/hard of hearing party. The voice imprint may be stored on video computing processing device 15 or in relay center 19, such as in first telephony device 29. A virtual identity function code may be preselected by the deaf party prior to the conservation with the hearing party so that the interpreter's voice is converted on the first telephony device or other system. This code is used to designate the predetermined voice profile selected by the deaf party. The virtual identity function code may be transmitted to the relay center 19 via first relay link 17 or the identity function code may be stored in relay center 19. It should be recognized that the voice synthesizer arrangement with a virtual identity function code may be applied to a TRS environment. In the video relay or TRS environment the deaf party can selectively choose a virtual audio identity.

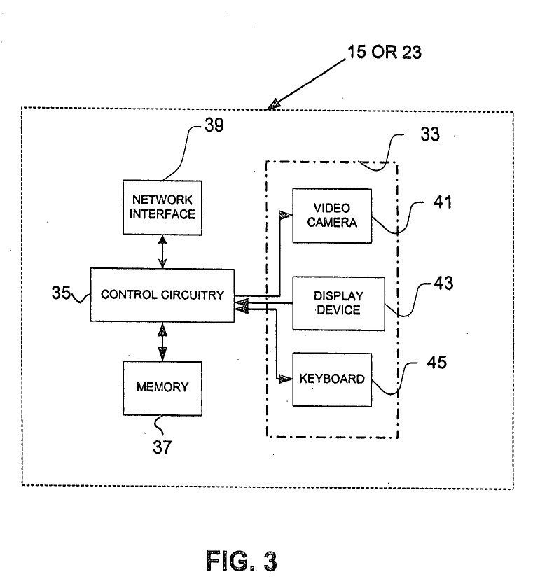

FIG. 3 is a schematic diagram of a video computing device for implementing the video relay service of the present invention, in which the deaf party may use video computer processing device 23 for communications with relay interpreter 21, shown in FIG. 2. It should be recognized that video communication relay center 19, may also include a video computer processing device as well. Nevertheless, as shown in FIG. 3, video computer processing device 15,23 may include several electronic and software components including a user interface 33, a control circuitry 35, a memory 37, and a network interface 39. Each component will be described in detail herein.

Referring to FIG. 3, user interface 33 is a component of video computer processing device 15,23 that transmits out-bound visual signals and receives in-bound visual signals relating to deaf party 13 of the device. User interface 33 is operatively connected to the control circuitry 35 and includes at least a video camera 41, and a display device 43. Display device 43 provides visual signals and cues to the user in the form of alphanumeric characters, colors, graphics, and video movements. Display device 43 may be a known display device, such as a liquid crystal display, or computer monitor. The display surface of the device 43 may include one or more video windows for viewing the interpreter or displaying additional information. The display surface may include a number of icons logically mapped to various functions of the video communications relay center. Further to explain user interface 33, video camera 41 may be configured to receive visual input data from the deaf party and the relay interpreter in sign language or other types of visual cues. In one example, the sign language may be American Sign Language (ASL). Video camera 41 may be any number of suitable video cameras for digital use, such as commercially available web-cameras. Optionally, a keyboard 45 may be included with user interface 33 for chat purposes similar to instant messaging. This enables the deaf party to communicate with the VRS in the case of entering of text data.

With continued reference to FIG. 3, control circuitry 35 includes hardware and software that enables the VCPD to operate in access network 25 shown in FIG. 2. The control circuitry 35 may include a microprocessor for use on digital networks. Also, the control circuitry may typically include operating software and a network interface 39 that enables VCPD 15,23 to connect to the associated network, such as access network 25. In one arrangement, the video computer processing device may operate with commercially available operating software, such as MICROSOFT WINDOWS2), WINDOWS NTO, UNIXO, LINUXO or other variations of the operating software. Control circuitry 35 also includes an operable connection to memory 37. In general, memory 37 stores computer readable data installed or programmed by a user, such as the deaf party or the relay interpreter. Memory 37 can be any type, which provides nonvolatile storage that can be electrically erased and/or reprogrammed. In one arrangement, memory 37 may be embodied a computer-readable storage device that may include one or more magnetic disk drives or, alternatively, optical disk drives such as Compact Disk ROMs, or DVD drives. In other arrangements, the memory may include read only memory (“ROM”) and random access memory (“RAM”).

Some suitable video computer processing devices include, but are not limited to a personal computer configured with a digital video camera, a web browsers, and network connections to the World Wide Web; a videophone, such as MM2250 manufactured by Motion Media Technology, Inc. of North Carolina; and a video conferencing product called ENVISION@ by Sorenson Vision, Inc. of Utah. It should be recognized that the video processing devices are configured with a standardized family of telecommunication protocols, such as the H. 320 standard used for ISDN videoconference systems and videophones; and the H. 323 standard used for real-time multimedia communications on packet-based networks having an Internet Protocol (IP), such as the Internet. Other appropriate protocols may be used to provide the video data links.

In other arrangements of the first embodiment, video telephone systems operating over broadband CATV networks may include coaxial, fiber optics, and hybrid fiber networks, in which a real-time video message may be provided to the subscriber making the call. In further arrangement, a wireless phone that has a display screen enabled to receive video transmitted to the phone via the network as communications speed increases for real-time communications. The wireless phone may also include software such as Wireless Application Protocol or other software for wireless World Wide Web access for displaying on the phone.

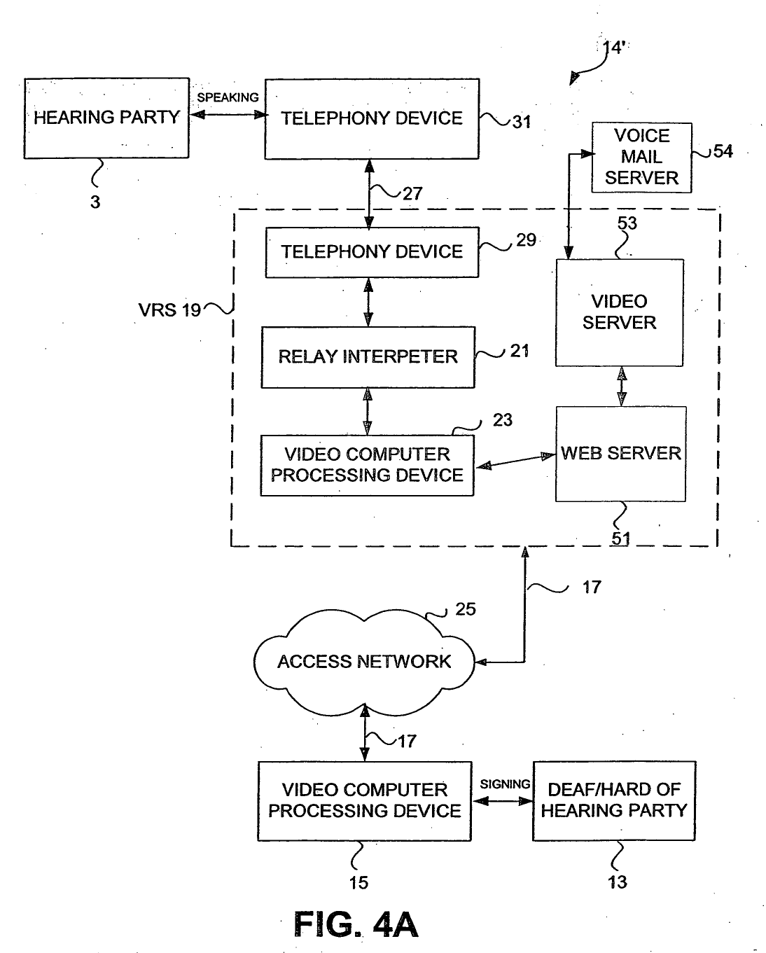

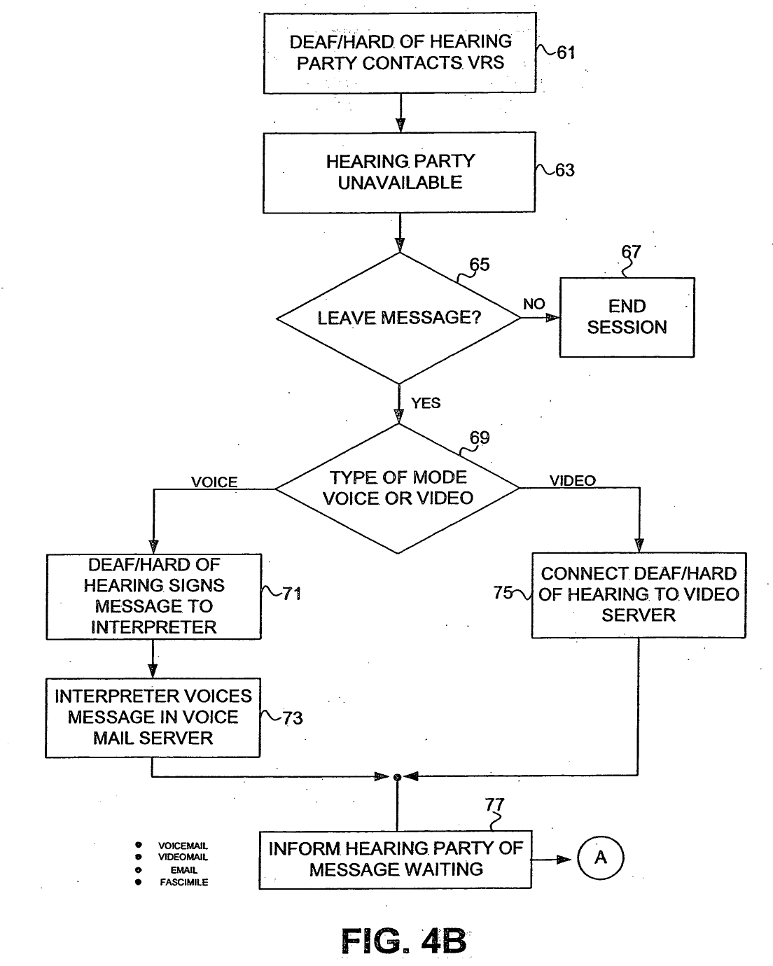

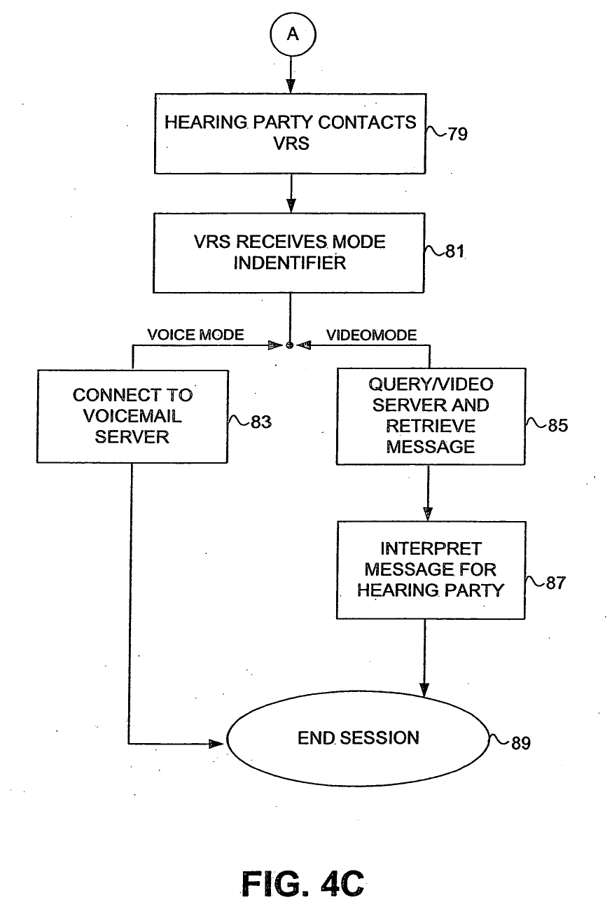

Referring to FIGS. 4A-4C, there is shown a second embodiment of a system and method for providing a video communications relay network 14′ of the present invention. Referring to FIG. 4A, relay network 14′ is similar to relay network 14. Network 14′ advantageously includes a messaging storage and retrieval arrangement. In the second embodiment, the messaging storage and retrieval arrangement includes a web server 51 coupled to a video server 53. The web server 51 executes one or more web-applications for web pages in which a subscriber, such as deaf/hard of hearing party 13, can retrieve prerecorded video messages in sign language from video server 53. Likewise, the subscriber is enabled to record a video message in sign language and to store the message on video server 53 for later playback. In addition, a relay interpreter 21 may leave a voice message for hearing party 3 in a voice mail server 54, as more fully explained herein.

Web server 51, video server 53 and voice mail server 54 can be each embodied in host computers that include one or more central processing units, a system memory, and a system bus that couples together the system components, including the system memory to the central processing unit. In particular, video server 53 includes computer-readable storage devices, such as a magnetic hard drives for storing full motion video data similar to a digital video recorder. Voice mail sever 54 also includes a computer-readable storage device as known in the art for storing and retrieving a plurality of recorded digital audio files. While FIG. 4A depicts a single web server 51, video server 53, and voice mail server 54, VRS 19 may include a plurality of web servers, video servers, and voice mail servers.

With reference to FIGS. 4B-4C, a method of video and voice messaging is shown. In block 61, deaf/hard of hearing party 13 contacts the VRS 19 to reach hearing party 3. In block 63, if party 3 is not available to speak to party 13, the network connected to telephony device 31 can return an unavailable status signal to relay interpreter 21, such as a busy signal, no answer signal, or a voice mail message. In block 65, VRS 19, via relay interpreter 21, informs party 13 of the unavailable status of party 3. Accordingly, deaf/hard of hearing party 13 may leave a video message for party 3 in video server 53. In block 67, deaf/hard of hearing party 13 can end the session on VRS 19.

To form the video message, deaf/hard of hearing party 13 communicates, via VCPD 15, in sign language to relay interpreter 21. In block 69, according to the second embodiment of the invention, there are two modes of messages that can be left for hearing party 3—a voice mode or a video mode. In block 71, deaf/hard of hearing party signs the message to interpreter 21. In block 73, relay interpreter 21 records a voice message on voice mail server 54 for later playback to party 3. Alternatively, in block 75, in the video mode, relay interpreter 21 may transfer party 13 to video server 53 via web server 51 so that party 13 can record the video message for party 3.

In block 77, after the voice message or video message is recorded, the relay interpreter or other entity, informs hearing party 3 that a message is waiting from the party 13. Advantageously, relay interpreter 21 provides a message mode identifier (MMI) and contact information to party 3 in an audio or a text message. MMI refers to a voice message or video message waiting on VRS 19. Relay interpreter 21 can leave an audio or a text message to party 3 in several approaches. For example, the relay interpreter can leave a message to party 3 to contact the video relay system in an e-mail, a facsimile, a pager message, or even a video e-mail to party 3. Thereafter, in block 79, hearing party 3 receives the contact message and consults VRS 19 to receive the waiting message. It should be recognized that addresses or phone numbers of hearing party 13 can be stored on VRS 19 or the deaf/hard of hearing party provides this information to relay interpreter 21.

In block 81, VRS receives the message mode identifier (MMI) from hearing party 3. VRS 19 provides the message from deaf/hard of hearing party 13 to hearing party 3 depending on the mode message identifier the voice mode, or the video mode. In block 83, the voice mode case, relay interpreter 21 may manually connect party 3 to the voice mail server. Alternatively, hearing party 3 may be given a telephone number, such as a toll-free number, that connects directly to video mail server 54. In such a case, the hearing party 3 has been provided with a voice mail box number and/or access code to retrieve the message from voice mail server 54. In block 85, the video mode case, hearing party 3 provides the relay interpreter with a video message ID code that corresponds to the video message on video server 53. Relay interpreter 21 queries video server 53 and retrieves the recorded video message from deaf/hard of hearing party 13 stored on the video server 53. In block 87, to provide the contents of the recorded video message, relay interpreter 21 views and interprets the recorded voice message in an audio form into first telephony device 29 for transmission to hearing party 3. If desired, hearing party 3 is enabled to contact deaf/hard of hearing party 13 through VRS 19. In block 89, the session with the hearing party ends.

It should be appreciated that the second embodiment can be implemented in a reverse manner. In operation, hearing party 3 can contact VRS 19 to reach deaf/hard of hearing 13. If deaf/hard of hearing party 13 is unavailable, hearing party 3 can leave a message for party 13. In this case, relay interpreter 21 interprets the speech of hearing party 3 so that a sign language video message is recorded in video server 53 for party 13. Thereafter, relay interpreter 21 informs party 13 that a message is waiting on VRS 19. There are several approaches to inform party 13 of the waiting message. The VRS 19 can send a text based e-mail to party 13; party 13 may log-on to video server 53 via web server 51 to view the sign language video message; or a message waiting signal on VCPD 15 may be actuated by VRS 19. Alternatively, the sign language message can be sent to party 13 in a video e-mail for local playback on VCPD 15. Advantageously, VRS 19 serves as a communication messaging center for hearing individuals and deaf/hard of hearing individuals.

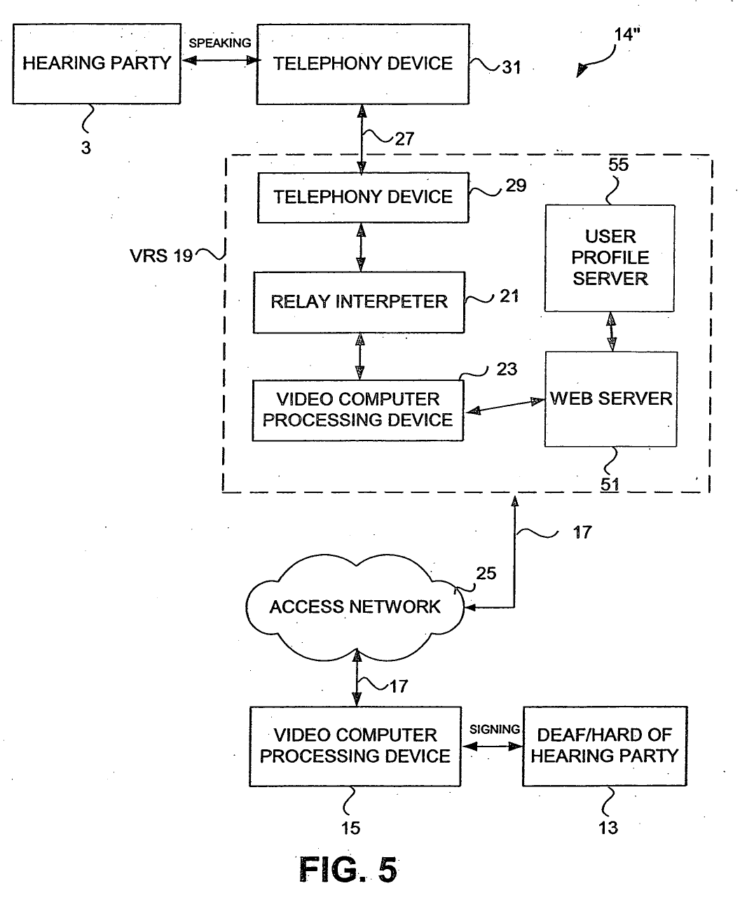

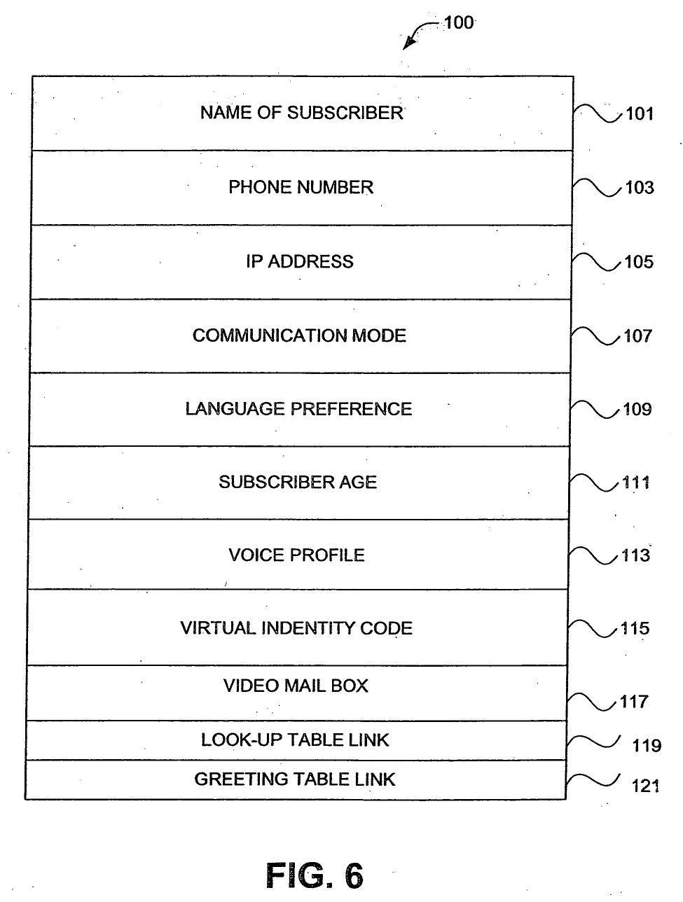

FIGS. 5-8, illustrate a third embodiment of a system and method for providing a video communications relay network 14″ of the present invention. Relay network 14″ is similar to relay network 14. Relay Network 14″ includes a predetermined user profile arrangement. In the third embodiment, the predetermined user profile arrangement includes web server 51 coupled to a profile server 55. The web server 51 executes one or more web-applications for executing web pages in which a subscriber, such as deaf/hard or hearing party 13, can store a specific subscriber profile in profile server 55. Likewise, VRS 19 can automatically and selectively retrieve a subscriber profile from profile server 55. Profile server 55 includes a computer readable storage device having a plurality of subscriber profiles. One example of a subscriber profile 100 is shown in FIG. 6. While FIG. 5 depicts a single web server 51 and profile server 55, VRS 19 may include a plurality of web servers and profiles servers according to the third embodiment.

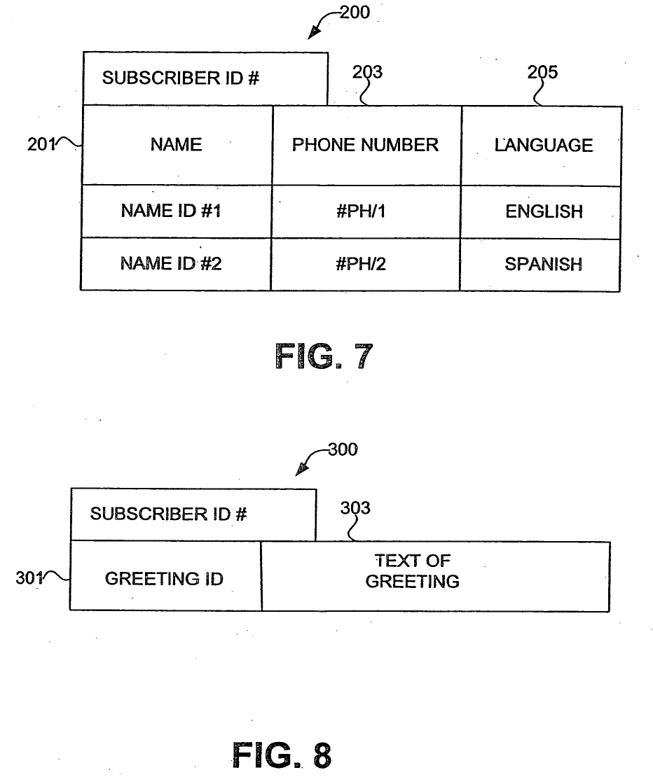

Referring to FIG. 6, subscriber profile 100 includes a plurality of attribute data or fields 101-117. Fields 101-119 contains data that causes VRS 19 to execute certain actions. Field 101 contains the name of the subscriber. Field 103 contains a contact phone number of the subscriber. Field 105 contains the Internet Protocol address of the subscriber device, such as VCPD 15. Field 107 contains a desired mode communication. In field 107, the mode of communication is linked to a one-way or a two-way communications to a hearing party. Field 109 contains a language preference of the subscriber. In one case, the language preference refers to the voice language for hearing parties contacted by party 13, such as English, Spanish, French or other languages. In another case, the language preference can relate to the desired type of sign language the deaf/hard of hearing party wishes to communicate with a relay interpreter. The type of sign language may be American Sign Language or Pidgin Signed English. Field 110 contains the age of the subscriber. Field 113 contains a digital voice profile that the subscriber has preselected. Field 115 contains the virtual identity code of the subscriber. Field 117 contains a video mailbox designation. Field 119 can be linked to a look-up table 200 shown in FIG. 7. In addition, another field is associated with greeting look-up table for each subscriber as show in FIG. 8.

As shown in FIG. 7, look-up table 200 includes a phone number directory to persons that the deaf party 13 has contacted in the past through the VRS or had otherwise populated the look-up table. Fields 201-205 contains data that causes VRS 19 to execute certain actions. Field 201 includes a name of a hearing party. Field 203 includes the phone number of the hearing party. Field 205 includes a voice language for the hearing party. All these fields are logically linked to a specific subscriber to the VRS 14″. As shown in FIG. 8, greeting look-up table 300 includes fields 301-303. Field 301 contains a greeting identification number or code. Field 303 includes the linked text of the greeting for display to the relay interpreter 21. As can be appreciated, a plurality of greeting identification numbers can be used with the system.

In operation, when a subscriber, such as party 13, contacts VRS 19, a web-page is activated via web server 51. The subscriber logs-on in a conventional manner with a user identification login and password into web server 51. Web server 51 runs a web client application that sends a request to profile server 55 for a subscriber profile. Profile server 55 performs a query on the internal database, and returns the requested subscriber profile, such as profile 100. The subscriber profile is displayed to the relay interpreter 21. Relay interpreter 21 prompts or otherwise determines the phone number that party 13 wants to call. In addition, a greeting can be preselected by the deaf party so the interpreter can use accordingly. This display of the preselected greeting eliminates delays when the relay interpreter connects to the hearing party. From the subscriber profile, the VRS is enabled to select the relay interpreter that best meets the needs of the subscriber for the particular video call. To select the interpreter, fields 107,109, 110, and look-up table 200 can be used. For example, if the phone number of the hearing party is in the look-up table for the deaf party, then a preferred language can be retrieved and a relay interpreter for the preferred language can be selected.

Likewise, the operation works in a reverse manner, in which hearing party 3 contacts VRS 19 to speak to deaf/hard of hearing party 13. Prior to relay interpreter 21 answering the call, the inbound phone number of party 13 is retrieved by caller ID, automatic number identification (ANI), or calling party name ID methods. This retrieved phone number can be used to associate a subscriber profile on VRS 19 with the caller. This retrieval function can be accomplished by querying profile server 55 to access the look-up tables. This is similar to a reverse directory look-up procedure being accomplished by profile server 55. Once the subscriber is determined, the associated subscriber profile is retrieved from profile server 55 and displayed to relay interpreter 21. Advantageously, the data populated in the look-up table fields can inform the relay interpreter of the preferred language of the caller. The subscriber profile can be used for contacting deaf/hard of hearing party 13 and the preselected greeting reduces the time of processing the calls.

Thus, a system and method for providing a video communications relay service to enhance communication choices of deaf, hard of hearing, or speech-impaired individuals over communications networks as been described. The aspects of the system and method have several advantages singularly or together have synergistic effects, such as enabling a user to employ sign language as his or hers natural language for leaving messages; enhanced communication by way of facial expression/body language cues between the deaf party and interpreter that provides emotional impact; elimination of communication barriers for slow typists and/or exclusive American Sign Language users; the ability to make interruptions during the conversation which what was not possible with text-based systems and the ability to send and retrieve messages in a natural language.

It should be appreciated the described embodiments can have the individual features and sub-combinations of these features to obtain some of the aforementioned advantages without the necessity to adopt all of these features. It should be recognized that described system and methods can be implemented in a TRS environment, such that a deaf party may be given choice to use a text-telephone or a video processing device by prompting of VRS 19.

All U.S. Patents referred to in the foregoing are expressly fully incorporated by reference for all purposes. While the present invention has been described with reference to preferred and exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention include all embodiments falling within the scope of the appended claims.

We claim:

1. A method of remote video interpreting using a relay system to facilitate communications between a first party using a video communication platform and a second party using an audio telephony platform, the relay system having a plurality of interpreters, the method of remote interpreting comprising the steps of:
receiving, at the relay system, a request for a network connection to the second party from the first party; and retrieving a predetermined user-specific profile for the first party in which the predetermined profile includes at least a language preference;
responsive to the step of retrieving, prompting the first party corresponding to the language preference for a network address linked to the audio telephony platform; establishing the network connection to the network address having the audio telephony platform of the second party;
the relay system receiving a real-time sign language input from the video communications platform of the first party;
formatting the real-time sign language input directly into spoken words while relaying, via the network connection from the relay system, the spoken words to the second party that corresponds to the formatted real-time sign language input from the first party.

2. The method of claim 1, wherein the step of receiving a request, further comprises the step of receiving the request in a videophone call.

3. The method of claim 1, further comprising the step of receiving an identity function code so that the second party can hear a synthesized voice corresponding to a preselected voice profile.

4. The method of claim 1, wherein the step of relaying further comprises the step of generating a synthesized voice identity corresponding to the first party.

5. The method of claim 1, further comprising the step of receiving the request in a web page connected to the World-Wide-Web.

6. The method of claim 1, wherein the step of retrieving the subscriber profile includes accessing a database including at least one of a previous network address and a linked language preference.

7. A remote video interpreting system to facilitate communications between a first party and a second party, comprising:
a video communication platform for displaying and receiving real-time sign language data via a first relay link;
a relay center being connected to the first relay link and a second relay link, the first relay link for receiving the sign language data so that the real-time sign language data can be converted into a spoken message, and the second relay link for transmitting the spoken message to an audio telephony platform; and
a profile server coupled to the relay center, the profile server for providing a user-specific subscriber profile of the first party.

8. The system of claim 7, wherein the audio telephony platform is selected from a group comprising: a personal computer equipped with a voice modem, a wireless phone, a laptop with a voice modem, a telephony-enabled personal digital assistant, a handheld terminal device, a palm-sized computer, and an IP-enabled telephone.

9. The system of claim 7, further comprising a web server coupled the first relay link.

10. The system of claim 7, wherein the video communication platform further comprises a memory for storing an identity code for transmission through the first relay link to the relay center, the identity code causing the relay center to transmit a synthesized voice through the second relay link corresponding to a preselected voice profile.

11. The system of claim 7, wherein the relay center retains a predetermined identity code established by the first party so that the audio telephony platform receives the spoken message in a synthesized voice corresponding to a predetermined digital voice profile.

12. The system of claim 32, wherein the predetermined digital voice profile is voice imprint of the first party.

13. A method of remote video interpreting using a relay system to facilitate communications between a first party using a video communication platform and a second party using an audio telephony platform, the relay system having a plurality of interpreters, the method of remote interpreting comprising the steps of:
receiving, at the relay system, a request for a network connection to the first party from the second party; and retrieving a predetermined user-specific profile for the first party in which the predetermined user-specific profile includes at least a language preference;
responsive to the step of retrieving, prompting the second party for a network address linked to the video communication platform;
establishing the network connection to the network address;
the relay system receiving a real-time audio input from the second party from the audio telephony platform; and
relaying, via the network connection from the relay system, the audio input to the first party in sign language.

14. The method of claim 13, wherein the step of receiving a request, further comprises the step of receiving the request in a videophone call.

15. The method of claim 13, further comprising the step of receiving an identity function code so that the second party can hear a synthesized voice corresponding to a preselected voice profile.

16. The method of claim 13, further comprising the step of receiving the request in a web page connected to the World-Wide-Web.

17. The method of claim 13, wherein the step of retrieving the subscriber profile includes accessing a database.
